(19) United States
(12) Patent Application Publication
(10) Pub. No.: US 2026/0062260 A1
(43) Pub. Date: Mar. 5, 2026

(54) A LIFTING SYSTEM FOR LIFTING COMPONENTS TO AN ELONGATED STRUCTURE

(71) Applicant: Skyrex AB, Göteborg (SE)

(72) Inventor: Michael Strandberg, Upplands Väsby (SE)

(21) Appl. No.: 19/105,149

(22) PCT Filed: Aug. 23, 2023
(86) PCT No.: PCT/EP2023/073079

§ 371 Date: Feb. 20, 2025

(30) Foreign Application Priority Data
Aug. 30, 2022 (EP) 22192977.1

(51) Int. Cl. B66C 23/18; B66C 1/28; B66C 1/34

(52) U.S. Cl. CPC B66C 23/18; B66C 1/28; B66C 1/34

(57) ABSTRACT

The present invention relates to a lifting system (1) comprising a tower (3), a jib (4) for lifting components to an elongated structure (2), a plurality of securing members (5) for securing the tower (3) to the elongated structure (2), and a lifting device (6) for lifting the securing members (5) and moving the securing members (5) up and down along the tower (3). The lifting device (6) comprises a platform (7) attached to an upper portion of the tower (3), protruding on two opposite sides of the tower (3) so that a first portion (7a) of the platform is protruding on a first side of the tower (3) and a second portion (7b) of the platform is protruding on a second side of the tower, a crane (10) arranged on the first portion (7a) of the platform, and a winch (12) for operating the crane arranged on the second portion (7b) of the platform. The crane (10) is arranged movable along the first portion (7a) of the platform so that the horizontal distance between the tower (3) and the crane (10) can be adjusted.

### TECHNICAL FIELD

The present invention relates to a lifting system for lifting components to an elongated structure. The system comprises a tower, a jib arranged on top of the tower for lifting components to the elongated structure, a plurality of securing members for securing the tower to the elongated structure, and a lifting device for lifting the securing members and moving them to their respective positions. The lifting system can, for example, be used to lift components to a wind turbine tower.

### BACKGROUND

Wind turbine towers today require regular maintenance of its main components, such as rotor blades, gear boxes and generators. However, these components are often large and heavy, which poses an issue during both the assembly and the maintenance of the wind turbine towers. Wind turbine towers today can be made higher than ever, with possible heights over 200 meters. Cranes for assembling and maintaining wind turbine towers can also be used to assemble and perform maintenance on other elongated structures such as buildings or towers.

JP2009113922 discloses a lifting system for performing work on an elongated structure, such as a wind turbine tower. The system comprises an elongated tower, a lifting device supported at the upper end of the tower for lifting components to the top of the elongated structure, and plurality of mounting members for securing the tower to the elongated structure. The mounting members are arranged at a distance from each other along the tower in the longitudinal direction of the tower. The mounting members can be connected to the elongated structure at appropriate positions. The document does not mention how the mounting members are moved to their appropriate positions.

EP3812337A1 discloses a lifting system for performing work on an elongated structure, such as a wind turbine tower. The system comprises tower segments to be stacked to form an elongated vertical tower, a base frame arranged to stack tower segments from below, a jib in a top part of the vertical tower, a lift cage for transporting people, a plurality of securing members for securing the tower to the elongated structure and fastening arrangements for securing the securing members to a tower segment at a desired height. The securing members are slidably connected to the tower to allow the securing members to be moved up and down along the tower. The securing members are provided with openings and the tower extends through the openings.

The lift cage is movably attached to a side of the vertical tower and is vertically moveable along the height of the vertical tower. The lifting system may comprise a tower segment jib for moving the lift cage along the height of the vertical tower, or the jib arranged in a top part of the vertical tower moves the lift cage. The lift cage is provided with a lifting arrangement arranged for moving the securing members along the tower height. The lifting arrangement is, for example, two arms comprising telescopic metal beams.

The securing members are heavy. Each securing member weights about 10 tons. It is necessary that the securing members are balanced when they are moved along the tower to avoid that they are hanging askew relative to the tower during the movement, which will impose shear forces on the tower and may cause the securing members to get stuck to the tower so that it is impossible to move the securing members along the tower. A problem with this solution for moving the securing members along the tower to their appropriate positions, is the difficulty in finding the point of balance for the securing members. The point of balance for a securing member may vary depending on various factors, such as the current positions of the arms of the securing member.

### SUMMARY

It is an aim of the present invention to at least partly overcome the above problem and to provide an improved lifting system for lifting components.

This aim is achieved by a lifting system as defined in claim 1.

The lifting system comprises a tower, a jib arranged on top of the tower for lifting components to an elongated structure, a plurality of securing members for securing the tower to the elongated structure, a lifting device for lifting the securing members and moving the securing members up and down along the tower. The lifting device comprises a platform attached to an upper portion of the tower, protruding on two opposite sides of the tower so that a first portion of the platform is protruding on a first side of the tower and a second portion of the platform is protruding on a second side of the tower. The lifting device further comprises a crane arranged on the first portion of the platform, and a winch for operating the crane arranged on the second portion of the platform, and the crane is arranged movable back and forth along the first portion of the platform so that the horizontal distance between the tower and the crane can be adjusted.

The securing member is in balance when it is lifted in its center of gravity. The tower is vertically arranged. Due to the fact that the crane is arranged movable back and forth along the first portion of the platform, it is possible to adjust the horizontal distance between the tower and the crane when the crane is loaded, i.e., when the crane is holding and lifting the securing member. Thus, it is possible to adjust the position of the crane until the center of gravity of the securing member is found and the securing member is in balance. When the securing member is in balance, the securing member hangs straight. Consequently, it is avoided that the securing member gets stuck to the tower and thereby achieves unwanted forces on the tower. When the securing member is in balance, the securing member will easily slide along the tower during the lifting of the securing member.

The winch is arranged to act as counterweight to the crane and its load. Thus, the winch acts as counterweigh to the securing member during the lifting.

A further advantage with the lifting system according to the invention, is that lifting device is in balance when the crane is unloaded. This facilitates mounting of the lifting system. Due to the fact that the platform has a first portion protruding on a first side of the tower and a second portion protruding on a second side of the tower, and the crane is arranged on the first portion of the platform, and the winch is arranged on the second portion of the platform, the platform is in balance when the crane is unloaded. This is possible since the weight of the winch is about the same as the weight of the crane and its accessories. It is also possible to achieve balance of the platform by adjusting the position of the crane.

With the term “platform is attached to an upper portion of the tower” is meant that the platform is attached to an upper half of the tower. The platform should be attached to the tower so that the lifting device is located well above the desired vertical positions of the securing members.

With the term “the crane is arranged movable back and forth along the first portion of the platform” is meant that the crane is movable along at least a part of the first portion of the platform.

According to an aspect of the present invention, the platform is removably attached to the tower. The lifting device is designed as a separate module which can be attached to and detached from the tower. Thus, the lifting device can be detached from the tower during transportation of the lifting system to and from the place where it is used. This facilitates transportation of the lifting system.

According to an aspect of the present invention, the platform is provided with an opening for receiving the tower, the platform protrudes on opposite sides of the opening, and the platform is provided with a fastening arrangement for removably attaching the platform to the tower. This lifting device is designed as a separate module which can easily be attached to and detached from the tower.

According to an aspect of the present invention, the fastening arrangement includes through holes and fastening elements, such as bolts, screws, and plungers. The tower can be provided with corresponding through holes for receiving the fastening elements.

Preferably, the fastening arrangement is arranged close to or in direct connection to the opening. The fastening arrangement is arranged in connection to the opening to provide a simple attachment of the platform to the tower segment.

According to an aspect of the present invention, the tower comprises a plurality of tower segments arranged to be stacked on top of each other to form the tower, wherein the platform is attached to one of the tower segments and protrudes on opposite sides of the tower segment. Thus, the lifting device can be mounted to one of the tower segments before the tower is raised, and accordingly the mounting of the lifting system is facilitated.

According to an aspect of the present invention, the platform is removably attached to one of the tower segments. Thus, the lifting device can easily be moved to another tower segment.

According to an aspect of the present invention, the opening is designed to receive one of the tower segments, and the fastening arrangement is arranged for removably attaching the platform to one of the tower segments. This makes it easy to mount the lifting device on one of the tower segments. It is also easy to move the lifting device to another tower segment.

According to an aspect of the present invention, the jib is arranged on top of an upper tower segment, and the platform is attached to the upper tower segment and below the jib.

According to an aspect of the present invention, the crane comprises a hook arranged movable up and down along the tower by means of the winch.

According to an aspect of the present invention, each of the securing members is provided with a lifting arrangement arranged to allow the crane to lift the securing members in its center of gravity.

According to an aspect of the present invention, the lifting arrangement comprises an elongated holding element, and a plurality of lifting elements arranged spaced apart on the securing member for engaging to the elongated holding element.

According to an aspect of the present invention, the hook is adapted to hold the elongated holding element during the lifting, and the elongated holding element is arranged so that its length on opposite sides of the hook can be adjusted when the crane is moved along the first portion of the platform.

According to an aspect of the present invention, the securing members are elongated and extend in a horizontal direction, the lifting elements are arranged spaced apart in the longitudinal direction of the securing member, and the ends of the elongated holding element are arranged to engage to the lifting elements. The tower is vertically arranged, and the lifting elements are arranged spaced apart in a horizontal direction. Since the lifting elements are arranged spaced apart in a horizontal direction on the securing member, the point where the crane lifts the securing member can be adapted to the current point of balance of the securing member.

According to an aspect of the present invention, the lifting engaging with the ends of the elongated holding element. The holding element is, for example, a metal wire or a chain or the like. The hook holds the elongated holding element during lifting of the securing member and the hook can be moved along the elongated holding element until the hook lifts the securing member in its point of balance.

According to an aspect of the present invention, the lifting device comprises a movable trolley arranged so that the crane is movable back and forth along the first portion of the platform. The trolley is arranged movable back and forth along the first portion of the platform, and the crane is attached to the trolley. The trolley makes it possible to move the crane with full load, i.e., when the crane is holding the securing member.

According to an aspect of the present invention, the crane comprises a first sheave and a second sheave attached to the movable trolley, and a third sheave attached to the hook. The lifting device comprises an elongated flexible element extending from the winch to the first sheave, from the first sheave to the third sheave, and from the third sheave to the second sheave. This is a simple type of crane and easy to move along the platform. The elongated flexible element is, for example, a rope, a wire, or a chain. The elongated flexible element is arranged between the winch and the hook so that the hook can be moved up and down in a vertical direction by operating the winch.

According to an aspect of the present invention, the securing member comprises a tower holding part that holds the securing member to the tower and a fastening module for securing the tower to the elongated structure, wherein the tower holding part is slidably connected to the tower to allow the securing member to be moved up and down along the tower.

### BRIEF DESCRIPTION OF THE DRAWINGS

The invention will now be explained more closely by the description of different embodiments of the invention and with reference to the appended figures.

FIG. 1 shows an example of a lifting system for lifting components to an elongated structure.

FIG. 2 shows a perspective view of an example of a lifting device of the lifting system.

FIG. 3 shows a side view of the lifting device in FIG. 2.

FIG. 4 shows a view from above of the lifting device in FIG. 2.

FIG. 5 shows an upper portion of the lifting system in a perspective view.

FIG. 6 shows the lifting system lifting a securing member with the crane in a first position at a distance from the tower.

FIG. 7 shows the lifting system lifting a securing member with the crane in a second position closer to the tower.

FIG. 8 shows another example of the lifting system during lifting of a securing member.

### DETAILED DESCRIPTION

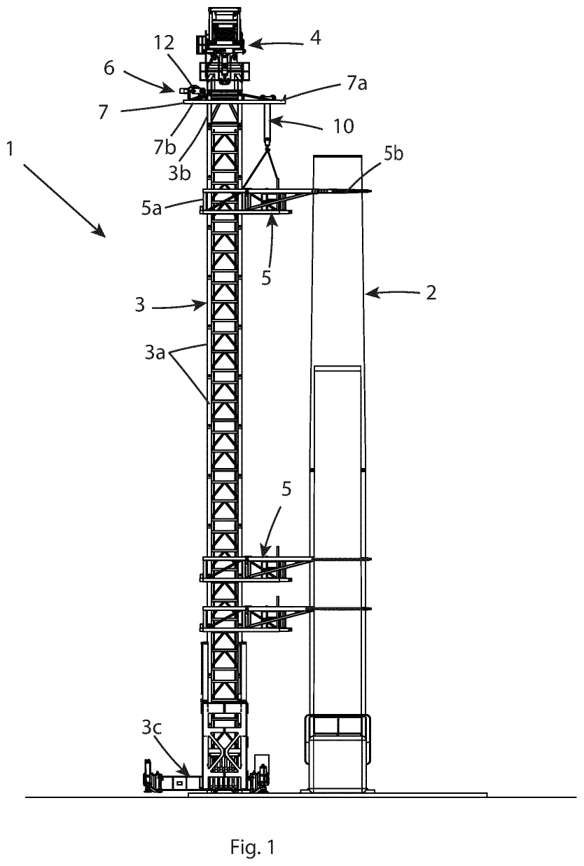

FIG. 1 shows an example of a lifting system 1 for lifting components to an elongated structure 2. The elongated structure is, for example, a tower of a wind power plant. The lifting system 1 is, for example, suitable for use during maintenance of wind turbines. The lifting system can be used to lift components, such as rotor blades, gear boxes and generators to the top of a wind turbine tower. The lifting system 1 can also be used during mounting of new wind turbine towers. This involves lifting of tower parts on top of each other and installation at the top of the nacelle with a weight of about 120 tons.

The lifting system 1 comprises a vertical tower 3, a jib 4 arranged on top of the tower 3 for lifting components to the elongated structure 2, a plurality of securing members 5 for securing the tower 3 to the elongated structure 2, and a lifting device 6 for lifting the securing members 5 and moving the securing members 5 up and down along the tower 3. The tower is elongated and extends in a vertical direction. The lifting system 1 may also comprise a base frame 3c arranged to support the tower 3. In this example, the tower, in a cross-section, has a rectangular shape. However, the tower can have other shapes. The lifting device 6 is designed to lift and move one of the securing members at a time. The securing members 5 are lifted to their positions and then fastened to the tower 5.

The securing members 5 are, for example, of the typed described in WO2020/229513. In this example, the securing member 5 comprises a tower holding part 5a that holds the securing member 5 to the tower 3 and a fastening module 5b for securing the tower 3 to the elongated structure 2. In the illustrated example, the fastening module 5b comprises two arms arranged to attach the securing member 5 to the elongated structure 2. The tower holding part 5a is slidably connected to the tower 3 to allow the securing member 5 to be moved up and down along the tower 3. The tower holding part 5a comprises an opening for receiving the tower 3. The securing member 5 is thus slidably connected to the tower 3 by receiving the tower 3 in the opening of the securing member. When the securing member has reached its desired position, the tower holding part 5a is attached to the tower 3 and the fastening module 5b are attached to the elongated structure 2. The securing members 5 are thus securing the tower 3 to the the elongated structure 2. The securing members 5 are attached to the tower 3 at spaced apart positions along the tower 3.

The lifting device 6 comprises a platform 7 attached to an upper portion of the tower 3, protruding on two opposite sides of the tower 3. The platform 7 comprises a first portion 7a protruding on a first side of the tower 3 and a second portion 7b protruding on a second side of the tower opposite the first side. The lifting device 6 comprises a crane 10 arranged on the first portion 7a of the platform, and a winch 12 for operating the crane 10 arranged on the second portion 7b of the platform. The winch 12 is arranged to act as counterweight to the crane 10 and its load, i.e., the winch 12 acts as counterweigh to the securing member 5 during the lifting. Since the securing members 5 are heavy, a large and heavy winch 12 is needed. Suitably, the weight of the winch is larger than 1000 kg, preferably the weight of the winch is larger than 1500 kg, and most preferably the weight of the winch is larger than 2000 kg.

The crane 10 is arranged movable back and forth along the first portion 7a of the platform so that the horizontal distance between the tower 3 and the crane 10 can be adjusted. Since the horizontal distance between the tower 3 and the crane 10 can be adjusted, it is possible to achieve that the center of gravity of the platform 7 and its load is in the center of the tower 3 during lifting and moving of the securing member 5. Thus, the platform 7 and its load is balanced and shear forces on the tower is avoided during the lifting of the securing member 5.

The platform 7 is removably attached to the tower 3. The lifting device 6 is designed as a separate module which can be attached to and detached from the tower 3. This facilitates transportation of the lifting system 1. The parts of the lifting system 1 can be transported on trucks, and the lifting system 1 is mounted on site, for example, at a wind power park.

In the illustrated example, the tower 3 comprises a plurality of tower segments 3a-b arranged stacked on top of each other to form the elongated tower 3. One of the tower segments is an upper tower segment 3b. The jib 4 is arranged on top of upper tower segment 3b. The tower segments 3a-b are attached to each other. For example, during raising of the tower 3, the tower segments 3a-b are lifted by means of a tower crane jacking system and thereafter attached to each other. In the illustrated example, the platform 7 is attached to the upper tower segment 3b and protrudes on opposite sides of the tower segment 3b. Alternatively, the platform 7 is attached to any of the other tower segments 3a in the upper portion of the tower 3. Preferably, the platform 7 is removably attached to the tower segment 3b. The lifting device 6 can be mounted to one of the tower segments 3a-b before the tower 3 is raised, and accordingly the mounting of the lifting system 1 is facilitated. Further, the lifting device 6 can easily be moved to another tower segment.

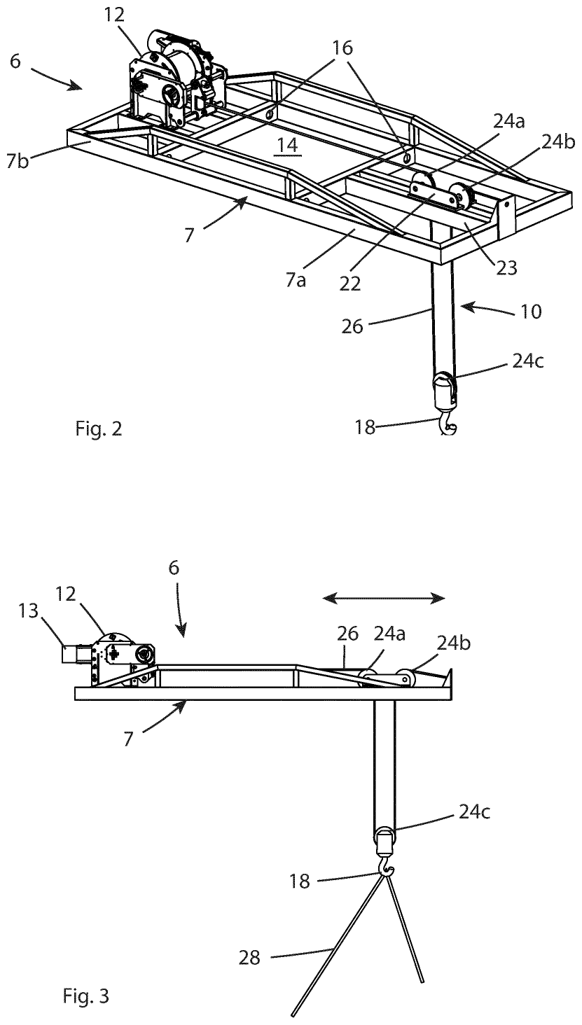

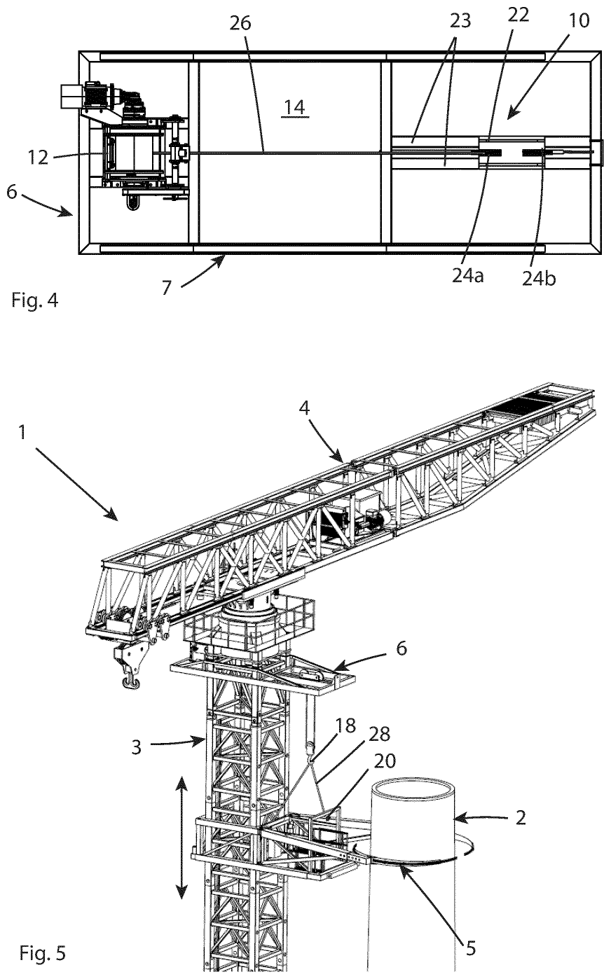

FIG. 2 shows a perspective view of an example of a lifting device 6 of the lifting system 1. FIG. 3 shows a side view of the lifting device 6, and FIG. 4 shows a view from above of the lifting device 6. The platform 7 is elongated and extend in a horizontal direction, i.e., in a direction perpendicular to the longitudinal direction of the tower 3. The platform 7 comprises a framework, which is preferably made of steel. The framework is, for example, made of a plurality of beams. In this example, the shape of the platform 7 is rectangular. However, the platform 7 can have other shapes, for example, oval.

In this example, the platform 7 is provided with an opening 14 for receiving one of the tower segments 3a, 3b. The opening 14 is disposed between the first and second portions 7a-b of the platform 7. The first and second portions 7a-b of the platform 7 protrude on opposite sides of the opening 14. The opening 14 has a shape and size that essentially corresponds to the cross-sectional shape of the tower 3. In this example, the opening 14 has a rectangular shape.

The lifting device 6 is designed as a separate module which can be removably attached to the tower 3. In this example, the platform 7 is designed to be removably attached to one of the tower segments 3a-b. The lifting device 6 is provided with a fastening arrangement for removably attaching the platform 7 to the tower 3, or to one of the tower segments 3a-b. The fastening arrangement may include screw joint reinforcements. In the illustrated example, the fastening arrangement comprises through holes 16 arranged in each corner of the opening 14 for receiving fastening elements, such as bolts, screws, and plungers. The tower segments 3a-b can be provided with corresponding through holes for receiving the fastening elements. However, other suitable fastening arrangement can be used.

In the illustrated example, the lifting device 6 comprises a movable trolley 22 arranged so that the crane 10 is movable back and forth along the first portion 7a of the platform 7, as shown in FIGS. 2 and 3. The crane 10 is attached to the trolley 22. For example, the trolley 22 is chain driven and is moved back and forth by means of an electric motor. Preferably, the movements of the trolley 22 can be remotely controlled. The weight of the crane and the trolley including the electric motor is about 1500 kg. Thus, weight of the crane 10 and the trolley 22 approximately corresponds to the weight of the winch 10. Thus, the lifting device is in balance when the crane is unloaded, which facilitates mounting of the lifting system.

In this example, the crane 10 comprises a first sheave 24a and a second sheave 24b attached to the movable trolley 22. The platform comprises rails 23 arranged in the first portion 7a of the platform and extending in a longitudinal direction of the platform 7. The trolley 22 is arranged movable along the rails 23 so that the crane 10 can be moved along the first portion 7a of the platform 7 to a desired position. Accordingly, the horizontal distance between the tower 3 and the crane 10 can be adjusted so that the securing member 5 is in balance. If the securing member 5 is not in balance, it is not possible to move the securing member 5 up and down along the tower 3.

In the illustrated example, the crane 10 comprises a hook 18 arranged movable up and down along the tower 3 by means of the winch 12. The winch 12 is preferably an electric winch having an electric motor 13, as shown in FIG. 3. Preferably, the winch can be remotely controlled. The lifting device 6 further comprises an elongated flexible element 26, such as a rope, a wire, or a chain, arranged between the winch 12 and the crane for moving the hook 18 up and down in a vertical direction by means of the winch 12. In this example, the crane 10 further comprises a third sheave 24c attached to the hook 18. Thus, the crane 10 comprises three sheaves 24a-c. Each of the sheaves is provided with a circular grove designed to house the elongated flexible element 26. The sheaves 24a-c can suitably be crane cable sheaves.

The first and second sheave 24a-b are arrange spaced apart on the trolley 22. Suitably, the distance between the first and second sheave 24a-b correspond to the width of the third sheave 24c. The elongated flexible element 26 extends between the winch 12 and the first sheave 24a on the trolley 22, and further from the first sheave 24a to the third sheave 24c attached to the hook 18. The elongated flexible element 26 extends from the third sheave 24c to the second sheave 24b arranged on the trolley 22. One end of the elongated flexible element 26 is attached to the winch 12 and the other end is attached to a front part of the platform, as shown in FIGS. 2 and 3.

FIG. 5 shows an upper portion of the lifting system 1 in a perspective view. The vertical movements of the hook 18 is achieved by the winch 12, and the horizontal movement of the hook is achieved by the movable trolley 22. The lifting system 1 comprises a lifting arrangement arranged to allow the crane 10 to lift the securing member 5 in its center of gravity. For example, the lifting arrangement comprises an elongated holding element 28 adapted to be hold by the hook 18 during the lifting and a plurality of lifting elements 20 arranged on the securing member 5. The elongated holding element 28 is, for example, a wire, a chain, or the like. The ends of elongated holding element 28 are adapted to engage to the lifting elements 20 so that the holding element 28 is attached to the securing member 5 during the lifting. For example, the ends of the elongated holding element 28 are provided with engaging elements, such as hooks or crooks, adapted to engage with the lifting elements 20 on the securing member 5. In the illustrated example, each of the securing members 5 is provided with a plurality of lifting elements 20, such as a lifting eye bolt or eye nut, provided with openings for engaging to the engaging elements of the elongated holding element 28, as shown in FIG. 5.

The hook 18 holds the elongated holding elements 28 during lifting and moving of the securing member 5. The elongated holding element 28 is arranged so that its length on opposite sides of the hook 18 can be adjusted when the crane is moved along the platform 7. Thus, the point where the crane lifts the securing member 5 can be adapted to the current center of gravity of the securing member. The length of the elongated holding element 28 is preferably longer than the distance between the lifting elements 20 so that the hook 18 can be moved in a horizontal direction along the elongated holding element 28 so that the length of the holding element on opposite sides of the hook 18 can be adjusted. Alternatively, the hook 18 can be provided with one or more bobbins that roll up the elongated holding element and the bobbin is arranged so that it is possible to adjust the length the elongated holding element on both sides of the hook.

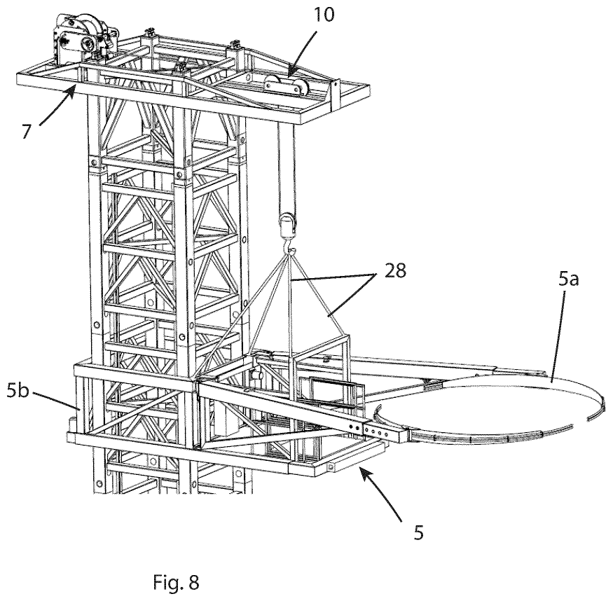

In the illustrated example, the lifting arrangement comprise a pair of horizontally spaced apart lifting elements 20 and one elongated holding element 28 extending between the lifting elements 20. Alternatively, the lifting arrangement may comprise two pair of horizontally spaced apart lifting elements 20 and two elongated holding elements 28 extending between the pair of lifting elements 20, respectively, as shown in FIG. 8.

In an alternative embodiment, the lifting elements 20 may comprises one or more elongated hole boards arranged on the securing member. The hole boards can be provided with a row of holes arranged at different positions along the securing member 5 for engaging to the holding element 28. Since many holes are arranged along the securing member, it is possible to select a hole at or in close vicinity to the current center of gravity of the securing member 5. Thus, the point where the crane 10 lifts the securing member 5 can be adapted to the current center of gravity of the securing member.

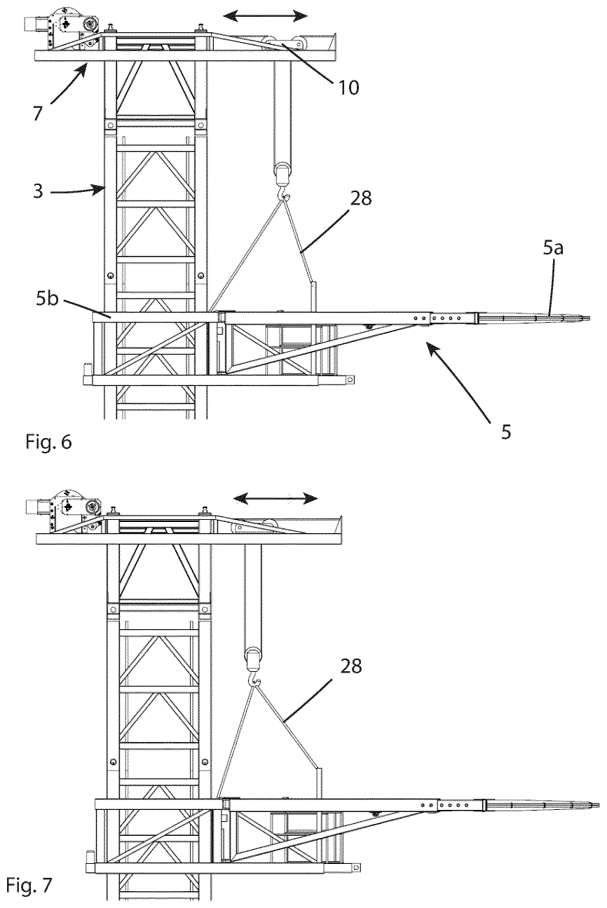

The crane 10 is arranged movable back and forth along the first portion 7a of the platform 7 so that the horizontal distance between the tower 3 and the crane 10 can be adjusted. Thus, the crane 10 can be moved to a position where the securing member 5 is in balance and does not tilt in any direction. The hook 18 holds the elongated holding element 28 during lifting of the securing member 5. The hook 18 can be moved along the elongated holding element 28 until the crane 10 lifts the securing member 5 in its point of balance. When the hook 18 moves along the elongated holding element 28, the length of the elongated holding element 28 on opposite sides of the hook 18 changes. FIG. 6 shows the lifting system 1 when it is lifting a securing member 5 with the crane 10 in a first position at a distance from the tower 3. FIG. 7 shows the lifting system 1 when it is lifting the securing member 5 with the crane 10 in a second position closer to the tower 3. It is to be noted that the length of the elongated holding element 28 on different sides of the hook 18 have been changed when the crane 10 has been moved between the first and second positions.

FIG. 8 shows another example of the lifting system during lifting of a securing member 5. In this example, the lifting arrangement comprises two elongated holding elements 28. Each of the holding elements 28 is attached to the securing member 5 by means of a pair of lifting elements 20. For example, the lifting arrangement comprises a 4-part lifting chain provided with hooks in the ends of the chains. The hook 18 holds the elongated holding elements 28 during lifting and moving of the securing member 5.

### REFERENCE LIST

1. lifting system
2. elongated structure
3. tower
3a tower segment
3b upper tower segment
3c base frame
4. jib
5. securing member
5a. tower holding part
5b. fastening module
6. lifting device
7. platform
7a. first portion of the platform
7b. second portion of the platform
10. crane
12. winch
13. motor of the winch
14. opening
16. through holes
18. hook
20 lifting elements
22 trolley
23 rails
24a first sheave
24b second sheave
24c third sheave
26 elongated flexible element
28 elongated holding element

1. A lifting system comprising:
a tower,
a jib arranged on top of the tower for lifting components to an elongated structure,
a plurality of securing members for securing the tower to the elongated structure, and
a lifting device for lifting the securing members and moving the securing members up and down along the tower, wherein the lifting device comprises a platform attached to an upper portion of the tower, protruding on two opposite sides of the tower so that a first portion of the platform is protruding on a first side of the tower and a second portion of the platform is protruding on a second side of the tower, a crane arranged on the first portion of the platform, a winch for operating the crane arranged on the second portion of the platform, and a trolley arranged movable back and forth along the first portion of the platform, wherein the crane is attached to the trolley so that the crane is arranged movable back and forth along the first portion of the platform and the horizontal distance between the tower and the crane can be adjusted.

2. The lifting system according to claim 1, wherein the platform is removably attached to the tower and the lifting device is designed as a separate module which can be attached to and detached from the tower.

3. The lifting system according to claim 1, wherein the platform is provided with an opening for receiving the tower, the platform protrudes on opposite sides of the opening and the platform is provided with a fastening arrangement for removably attaching the platform to the tower.

4. The lifting system according to claim 1, wherein the tower comprises a plurality of tower segments arranged to be stacked on top of each other to form the elongated tower, and the platform is attached to one of the tower segments and protrudes on opposite sides of the tower segment.

5. The lifting system according to claim 4, wherein the platform is arranged to be removably attached to one of the tower segments.

6. The lifting system according to claim 3, wherein the opening is designed for receiving one of the tower segments and the fastening arrangement is arranged for removably attaching the platform to the tower segment.

7. The lifting system according to claim 4, wherein the jib is arranged on top of an upper tower segment and the platform is attached to the upper tower segment and below the jib.

8. The lifting system according to claim 1, wherein the crane comprises a hook arranged movable up and down along the tower by means of the winch.

9. (canceled)

10. The lifting system according to claim 8, wherein the crane comprises first and second sheaves attached to said movable trolley, and a third sheave attached to the hook, and the lifting device comprises an elongated flexible element extending from the winch to the first sheave, from the first sheave to the third sheave, and from the third sheave to the second sheave.

11. The lifting system according to claim 1, wherein the lifting system comprises a lifting arrangement to allow the crane to lift the securing members, and the lifting arrangement comprises an elongated holding element, and a plurality of lifting elements arranged spaced apart on the securing members for engaging to the elongated holding element.

12. The lifting system according to claim 8, wherein the hook is adapted to hold the elongated holding element during the lifting, and the elongated holding element is arranged so that its length on opposite sides of the hook can be adjusted when the crane is moved along the first portion of the platform.

13. The lifting system according to claim 11, wherein the securing members are elongated, the lifting elements are arranged spaced apart in the longitudinal direction of the securing members, and the ends of the elongated holding element are arranged to engage to the lifting elements.

14. The lifting system according to claim 1, wherein the securing member comprises a tower holding part that holds the securing member to the tower and a fastening module for securing the tower to the elongated structure, wherein the tower holding part is slidably connected to the tower to allow the securing member to be moved up and down along the tower.
